(19) United States
(12) Patent Application Publication
(10) Pub. No.: US 2025/0317439 A1
(43) Pub. Date: Oct. 9, 2025

(54) MULTI-STAGE LOGICAL STORAGE AREA PROVISIONING

(71) Applicant: The Toronto-Dominion Bank, Toronto (CA)

(72) Inventors: Gary FONG, Toronto (CA); Yetunde Adunni Kafayat RUFAI, Toronto (CA); Ethel ZLOTNIK CHAVEZ, Toronto (CA); Shuyun HUANG, Toronto (CA)

(73) Assignee: The Toronto-Dominion Bank, Toronto (CA)

(21) Appl. No.: 19/174,408

(22) Filed: Apr. 9, 2025

Related U.S. Application Data
(60) Provisional application No. 63/631,740, filed on Apr. 9, 2024.

(51) Int. Cl. H04L 9/40; G06F 21/62

(52) U.S. Cl. CPC H04L 63/0861; G06F 21/629

(57) ABSTRACT

A computing system may be configured to: receive an instruction to provision a logical storage area; perform a first identity authentication based on a received representation of an identification credential and biometric data captured at the remote computing device; in response to successfully performing the first identity authentication, provision the logical storage area with an unlocked first software feature and a locked second software feature; after provisioning the logical storage area: determine that a second identity authentication has been successfully performed for the identification data, the second identity authentication using a different authentication technique than the first identity authentication; and in response to determining that the second identity authentication has been successfully performed, unlock the second software feature to grant access to additional software functionality in association with the logical storage area. Machine learning may be used in the authentication.

### CROSS-REFERENCE TO RELATED APPLICATIONS

The present application claims priority to U.S. provisional application 63/631,740 filed Apr. 9, 2024 and entitled “Remote Account Configuration System and Interface”, the contents of which are incorporated herein by reference in their entirety.

### TECHNICAL FIELD

The present application relates to systems and methods for provisioning a logical storage area.

### BACKGROUND

Bot based attacks and misuse is becoming increasingly difficult to address as bots have incorporated artificial intelligence (AI) training techniques to become more effective and to appear more human-like. For example, AI-bots may be better at evading detection and overcoming existing authorization procedures than traditional bots.

Verifying identity during provisioning of a logical storage area is one area where the increased bot capability has created new vulnerabilities. Existing approaches to identity verification can include security approaches that rely on user authorization and/or authentication processes. Existing authentication processes are configured to prevent the proliferation of accounts created or used by bots, such as spam bots or fraud bots. Existing approaches to identity verification may also provision a logical storage area with credentials, such as a username and password, and may be useful for recovering access to a logical storage area if such credentials are lost or deactivated.

Identity verification may be complicated due to physical limitations, such as geographic distances. For example, the entity being verified may be located in a region that is not proximate to a region associated with a verifier system. Furthermore, even when the distances involved are not large, it may be inconvenient to immediately perform identity verification in person.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method of graduated unlocking of software features;

FIG. 4 shows, in flowchart form, an example method of unlocking of software features;

FIG. 5 shows, in flowchart form, an example method of graduated unlocking of software features;

FIG. 6 shows, in flowchart form, an example method of providing a non-native user interface;

FIG. 7 shows, in flowchart form, an example method of graduated unlocking of software features; and

FIG. 8 shows, in flowchart form, an example operating environment having one or more geofences.

Like reference numerals are used in the drawings to denote like elements and features.

### DETAILED DESCRIPTION OF VARIOUS EMBODIMENTS

In one aspect there is provided a computer-implemented method. The method may include receiving, via a network interface and from a remote computing device, an instruction to provision a logical storage area, the instruction including identification data. The method may include performing a first identity authentication based on a received representation of an identification credential and biometric data captured at the remote computing device, the first identity authentication confirming that: the biometric data captured at the remote computing device corresponds to biometric data represented by the identification credential; and the identification credential corresponds to the identification data. The method may include, in response to successfully performing the first identity authentication, provisioning the logical storage area with an unlocked first software feature and a locked second software feature. The method may include, after provisioning the logical storage area: determining that a second identity authentication has been successfully performed for the identification data, the second identity authentication using a different authentication technique than the first identity authentication; and in response to determining that the second identity authentication has been successfully performed, unlocking the second software feature to grant access to additional software functionality in association with the logical storage area.

In some implementations, the first identity authentication may provide for remote identity verification and wherein the second identity authentication requires local (e.g., non-remote) identity verification, which requires physical verification at a physical premises.

In some implementations, physical verification at the physical premises may be provided using a physical token.

In some implementations, the physical token is associated with the identification credential. For example, the physical token may include the identification credential thereon.

In some implementations, the second identity authentication may be performed by scanning the physical token at a scanner situated at the physical premises.

In some implementations, the method may further include determining that a location of the remote computing device satisfies defined criteria. The first identity authentication may be performed in response to determining that the location of the remote computing device satisfies the defined criteria.

In some implementations, the defined criteria are configured to be satisfied when the remote computing device is outside a geofence but that it is not satisfied when the remote computing device is inside the geofence.

In some implementations, the geofence is defined based on a jurisdictional boundary.

In some implementations, the first identity authentication may use one or both of computer vision techniques and machine learning to confirm that the biometric data captured at the remote computing device corresponds to biometric data represented by the identification credential.

In some implementations, the identification credential may be an officially-issued identification credential.

In some implementations, the first software feature may enable a computing operation of a first type and wherein the second software feature enables performance of a computing operation of a second type.

In some implementations, unlocking the first software feature may enable accepting incoming electronic messages in association with the logical storage area. Unlocking the second software feature may enable sending outgoing electronic messages in association with the logical storage area.

In some implementations, unlocking the first software feature may enable a first computing operation based on a received incoming electronic message in association with the logical storage area. Unlocking the second software feature may enable sending outgoing electronic messages in association with the logical storage area to affect a second computing operation.

In some implementations, the method may further include storing one or both of the received representation of an identification credential and the biometric data captured at the remote computing device. The second identity authentication may be performed based on one or both of the received representation of an identification credential and the biometric data captured at the remote computing device.

In some implementations, the method may further include: determining that one or both of a location associated with the remote computing device and a parameter received from the remote computing device satisfy defined criteria for augmenting a native user interface into a non-native user interface; in response to determining that one or both of the remote computing device and the parameter satisfy the defined criteria: determining that a non-native user interface is to be provided to the remote computing device; generating the non-native user interface by passing one or more components of a native user interface to a machine learning system with an instruction to generate a non-native interface; and providing the non-native user interface to the remote computing device. The instruction may be received via the non-native interface.

In some implementations, the method may further include: determining that the remote computing device has entered a geofence; and in response to determining that the remote computing device has entered a geofence, trigger a notification at the remote computing device, the notification facilitating the second identity authentication.

In another aspect, a computing system for provisioning a logical storage area is described. The computing system may include a network interface and a processor in communication with the network interface. The computing system may include a memory coupled to the processor. The memory may store processor-executable instructions which, when executed, cause the processor to perform a method described herein. For example, the processor-executable instructions may cause the processor to: receive, via the network interface and from a remote computing device, an instruction to provision a logical storage area, the instruction including identification data; perform a first identity authentication based on a received representation of an identification credential and biometric data captured at the remote computing device, the first identity authentication confirming that: the biometric data captured at the remote computing device corresponds to biometric data represented by the identification credential; and the identification credential corresponds to the identification data; and in response to successfully performing the first identity authentication, provision the logical storage area with an unlocked first software feature and a locked second software feature; after provisioning the logical storage area: determine that a second identity authentication has been successfully performed for the identification data, the second identity authentication using a different authentication technique than the first identity authentication; and in response to determining that the second identity authentication has been successfully performed, unlock the second software feature to grant access to additional software functionality in association with the logical storage area.

According to another aspect there is provided a non-transitory computer readable storage medium comprising computer-executable instructions which, when executed, configure a processor to perform a method or perform one or more operations described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

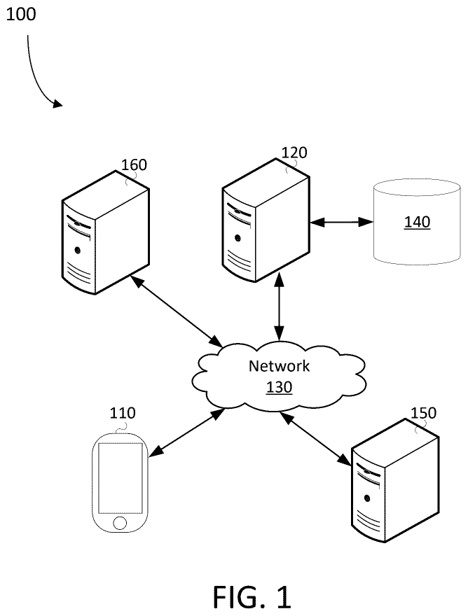

FIG. 1 is a schematic operation diagram illustrating an operating environment of an example embodiment. As shown, the system 100 includes a remote computing device 110 and a server computer system 120. The system 100 may also include an artificial intelligence (AI) engine 160 and/or a remote authentication server 150.

The AI engine 160 may be a computer system that processes and generates human-like text using a large language model (LLM). This system may include an application programming interface (API) that allows developers to integrate its capabilities into various applications, enabling functionalities such as natural language understanding, text generation, and contextual reasoning. The AI engine may also include translation components, such as a translation engine, that may support multilingual text processing, enabling users to translate content between languages with varying levels of fluency and accuracy. It may be hosted on cloud infrastructure, leveraging scalable computing resources to handle requests efficiently. The AI engine may incorporate advanced techniques such as fine-tuning, retrieval-augmented generation (RAG), and reinforcement learning to improve its performance over time. Security and access controls may also be implemented to ensure responsible usage and compliance with relevant data protection standards.

The remote authentication server 150 may be configured to authenticate an entity. Such authentication may include verification of identity. By way of example, the remote authentication server 150 may perform remote identity verification by validating user credentials against trusted identity providers, government databases, or third-party verification services. By way of example, in some implementations, the remote identity verification may be performed using an identification credential. The identification credential may be, for example, an identity document. Identity documents that may be used for authentication and verification purposes include passport, driver's license, national ID card, social security card (where applicable), state ID card, military ID, permanent resident card (green card), and visa., birth and citizenship documents such as birth certificates, certificate of naturalization, certificate of citizenship, and consular report of birth abroad, employment and tax-related documents such as an employee ID card, work permit, taxpayer identification number (TIN) document, social security number (SSN) card, bank statements, credit card statements, utility bills (electricity, water, gas, etc.), lease or mortgage statements, student ID cards, diploma or degree certificates, professional licenses (e.g., medical, legal, engineering), health insurance cards, Medicare/Medicaid cards, voter registration cards, and notarized affidavits of identity.

In some implementations, the remote authentication server 150 may be configured to perform authentication using OAuth. OAuth (Open Authorization) is an open standard for access delegation that enables secure authorization without exposing user credentials. It allows users to grant third-party applications limited access to their accounts on other services without sharing passwords. Instead, OAuth uses access tokens, which are issued by an authorization server upon user consent and can be used by applications to access protected resources on behalf of the user. This framework is commonly used in identity verification scenarios, where a service may rely on an external identity provider (such as Google™, Facebook™, or Microsoft™) to authenticate users.

The various devices illustrated in FIG. 1 may be coupled to one another via a network 130. For example, any of the remote computing device 110, the server computer system 120, the AI engine 160 and/or the remote authentication server 150 may be coupled to the network 130. The network 130 may include a public network such as the Internet and/or a private network. The remote computing device 110 and the server computer system 120 and/or any of the other systems illustrated in FIG. 1 may be in geographically disparate locations. Put differently, such systems may be located remote from one another.

The remote computing device 110 may take a variety of forms including, for example, a mobile communication device such as a smartphone, a tablet computer, a wearable computer (such as a head-mounted display or smartwatch), a laptop or desktop computer, or a computing device of another type. The remote computing device 110 may store software instructions that cause the remote computing device 110 to establish communications with the server computer system 120.

The server computer system 120 may include or be in communication with a data store 140, such as a memory or other memory store. The memory may be arranged into various logical storage areas. The logical storage areas may be or represent accounts or other segmented areas of memory. For example, a first logical storage area may represent data associated with a first account and a second logical storage area may represent data associated with a second account. Each of the accounts may be associated with different entities.

The data store 140 may, in some cases, include multiple data stores or elements, some or all of which may be remote from the server computer system 120.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

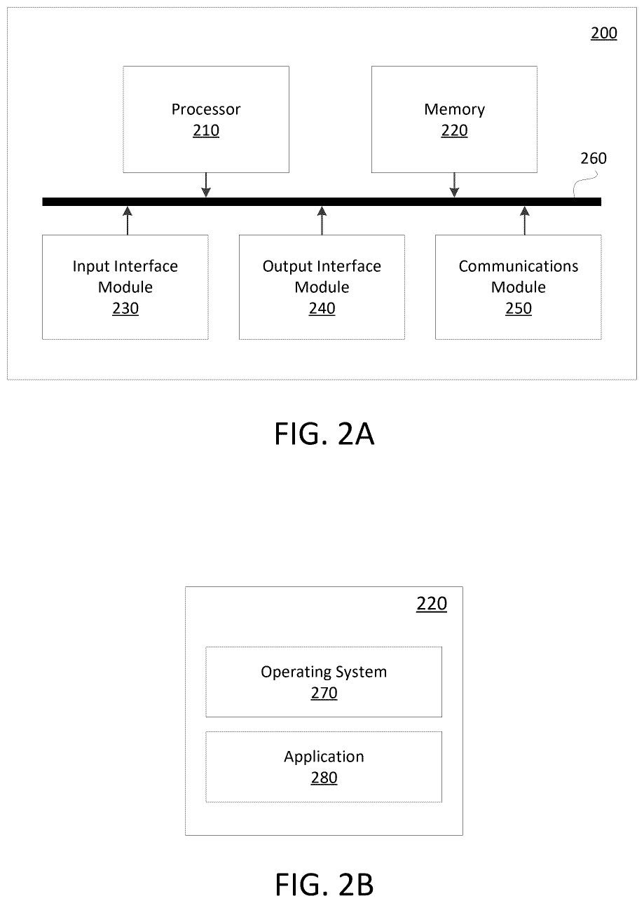

FIG. 2A is a high-level operation diagram of an example computer device 200. In some embodiments, the example computer device 200 may be exemplary of one or more of the remote computing device 110, the server computer system 120, the AI engine 160 and/or the remote authentication server 150. The example computer device 200 includes a variety of modules. For example, as illustrated, the example computer device 200, may include a processor 210, a memory 220, an input interface module 230, an output interface module 240, and a communications module 250. The communications module 250 may be, for example, a network interface. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, a camera or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by the output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset. The communications module 250 may be or may include a network interface.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

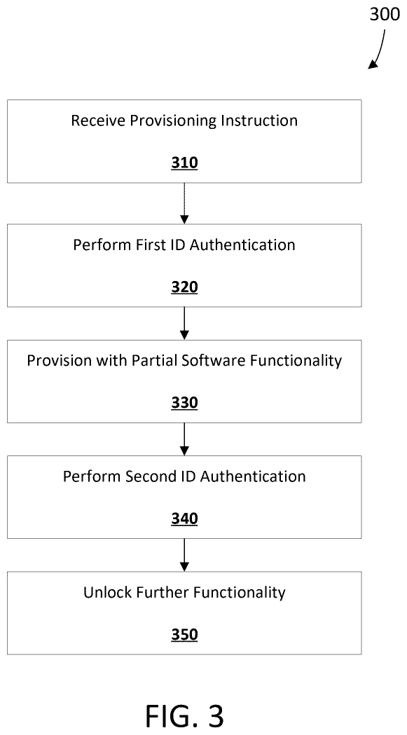

Reference is now made to FIG. 3, which illustrates an example method 300 for graduated unlocking of software functionality.

The method 300 may, in at least some implementations, be performed by one or both of a processor and a computer. For example, a memory may store instructions which, when executed, configure one or both of the processor and the computer to perform the method 300 or a portion thereof. “A processor” or “a computer” as used herein may include multiple processors or computers as the case may be. Similarly, “a memory” as used herein may include multiple memories. For example, the method 300 may be performed by a computing system, such as the server computer system 120 (FIG. 1). For example, processor-executable instructions may cause the processor of the computing system to perform the method 300.

At an operation 310, the method 300 may include receiving an instruction to provision a logical storage area. The instruction may be received from a remote computing device. The remote computing device may be operated by and/or associated with an entity. The instruction may be received via a network interface associated with the computing system performing the method 300.

In at least some implementations, the instruction may be an instruction to provision an account. The account may be of various types. By way of example, the account may be one or more of system administrator account, database account, cloud storage account, web hosting account, email account, developer account, code repository account, API service account, server management account, VPN account, project management account, document collaboration account, password manager account, social media account, messaging app account, video conferencing account, streaming service account, news subscription account, podcast platform account, gaming account, e-commerce account, online marketplace account, subscription box account, online learning account, university portal account, language learning account, health tracking account, telehealth account, gym membership account, travel booking account, airline loyalty account, hotel loyalty account, ride-sharing account, public transport account, tax filing account, government portal account, insurance account, utility provider account, bank account, credit card account, investment account, cryptocurrency wallet, loan account, mortgage account, and/or payment processor account.

The instruction may be received from a new entity. The new entity may be one or more of a new customer, client, consumer, user, patron, buyer, purchaser, subscriber, account holder, shopper, guest, member, beneficiary, recipient, participant, stakeholder, prospect, lead, end-user, visitor, applicant, registrant, investor, donor, supporter, partner, sponsor, delegate, attendee, requester and/or claimant. The new entity may be an entity that does not already have an associated logical storage area. For example, the new entity may not have an associated logical storage area in a data store 140 associated with the computing system performing the method 300. The new entity may not already have an associated account in a data store 140 associated with the computing system performing the method 300.

The instruction that is received at the operation 310 may include identification data. The identification data may identify the entity associated with the instruction. The identifying data may include any one or more of: a name, an address, a date of birth, a Social Security Number (SSN), a passport number, a driver's license number, a national identification number, a taxpayer identification number (TIN), a phone number, an email address, a username, a credit card number, a bank account number, a blockchain address, an authentication token, an employee ID, a student ID, a voter ID, and a signature. The identification data may be data that, when taken alone or in combination, uniquely identifies the entity.

At an operation 320, the method 300 may include performing a first identity authentication. The first identity authentication may be performed based on an identification credential. The identification credential may be a representation of a physical identification credential. The identification credential may be an officially-issued identification credential. The physical identification credential may be, for example, an identity document. Identity documents that may be used for authentication and verification purposes include passport, driver's license, national ID card, social security card (where applicable), state ID card, military ID, permanent resident card (green card), and visa., birth and citizenship documents such as birth certificates, certificate of naturalization, certificate of citizenship, and consular report of birth abroad, employment and tax-related documents such as an employee ID card, work permit, taxpayer identification number (TIN) document, social security number (SSN) card, bank statements, credit card statements, utility bills (electricity, water, gas, etc.), lease or mortgage statements, student ID cards, diploma or degree certificates, professional licenses (e.g., medical, legal, engineering), health insurance cards, Medicare/Medicaid cards, voter registration cards, and notarized affidavits of identity.

The identity document may be a photo identity document. That is, the identity document may include a photographic depiction of the entity identified by that document.

At the operation 320, the first identity authentication is performed. The first identity authentication may be performed based on the received representation of the identification credential, such as an image of the identification credential captured with a camera of the remote computing device. The first identity authentication may also be performed based on biometric data captured at the remote computing device. The biometric data may be, for example, a depiction or representation of a biometric feature. The biometric data may be, for example, an image of an entity's face (i.e., a facial image). The first identity authentication may be performed by confirming that: 1) the biometric data captured at the remote computing device corresponds to biometric data represented by the identification credential; and 2) the identification credential corresponds to the identification data. That is, the first identity authentication may confirm that the facial image corresponds to an image of the entity depicted on the identification credential and also that the identification credential includes data that corresponds to the identification data received along with the instruction at the operation 310. By way of example, this may include confirming a corresponding name, address, SSN, date of birth, etc.

In this way, at the operation 320, the first identity authentication may provide for remote identity verification.

At the operation 320, the first identity authentication may use computer vision techniques and/or machine learning. For example, such techniques may be used to confirm that the biometric data captured at the remote computing device corresponds to biometric data represented by the identification credential. In at least some implementations, facial recognition algorithms may be used at the operation 320. This process may involve detecting and extracting facial features from both images, normalizing them for variations in lighting and angle, and comparing them using deep learning models trained on large datasets of facial images. Techniques such as convolutional neural networks (CNNs) and embeddings may measure the similarity between the two faces, while anti-spoofing measures help detect fraud by distinguishing between live images and printed or manipulated photos.

In response to successfully performing the first identity authentication, a further operation 330 may be performed. At the operation 330, the method 300 may include provisioning the logical storage area with an unlocked first software feature and a locked second software feature. That is, at the operation 330, one or more features or functions associated with the logical storage area may be unlocked but another feature may be locked. As will be explained below with reference to the operation 350, this locked other feature may only be unlocked after another identity authentication has been performed.

The unlocked software feature at the operation 330 may be, for example, an incoming transfer and the locked software feature may be an outgoing transfer. For example, at the operation 330, the computing system performing the method may configure the logical storage area to enable it to receive incoming data transfers but it may prevent outgoing data transfers or may place other restrictions on the use of the data in the logical storage area. In this way, at the operation 330, only unidirectional data transfers may be enabled; bidirectional or omnidirectional data transfers may be prevented. In one example, at the operation 330, the computing system performing the method may configure the logical storage area to enable it to receive incoming transfers, but it may prevent the payload of a transfer from being accessed when it is stored in the logical storage area until the locked software feature is unlocked; for example, at the operation 350 described below.

In another example, the software feature that is unlocked at the operation 330 may be, for example, allowing for reading posts in association with an account and the locked software feature may operate to prevent publishing posts in association with the account. For example, the method 300 may operate in the context of a social media system. After the operation 330, the entity and/or the remote computing device may be able to perform some features, such as following various social media accounts, reading social media posts, etc., but it may be prevented from performing some other features that are available at the social media system to fully authenticated entities, such as publishing posts. This may prevent bots from publishing posts.

In some implementations, the first software feature unlocked at the operation 330 may enable a computing operation of a first type and the second software feature (that is not unlocked until the operation 350) may enable a computing operation of a second type.

In some implementations, unlocking the first software feature at the operation 330 enables accepting incoming electronic messages in association with the logical storage area. The second software feature, which is not unlocked until the operation 350, may enable sending outgoing electronic messages in association with the logical storage area.

In some implementations, the first software feature unlocked at the operation 330 may enable a first computing operation based on a received incoming electronic message in association with the logical storage area. The second software feature, which is not unlocked until the operation 350, may enable sending outgoing electronic messages in association with the logical storage area to affect a second computing operation.

The first software feature, which is unlocked at the operation 330, may also be referred to as a first computing operation, an unlocked computing operation, or an unlocked software feature. The second software feature, which is not unlocked at the operation 330 and remains locked, may also be referred to as a second computing operation, a locked computing operation, or a locked software feature.

After provisioning the logical storage area, the first software feature may be performed by the associated computing system in association with the provisioned logical storage area, but the second software feature may not be performed in association with the provisioned logical storage area. In this way, the provisioning of the logical storage area after the operation 330 is only a partial provisioning of the logical storage area.

After provisioning the logical storage area, a second identity authentication may be performed in order to unlock the second software feature. For example, at an operation 340, the method 300 may include determining that a second identity authentication has been successfully performed for the entity. The second identity authentication may use a different authentication technique than the first identity authentication. By way of example, in at least some implementations, the second identity authentication may require local (e.g., non-remote) identity verification. For example, the second identity authentication may require physical verification at a physical premises.

The physical verification at the physical premises may be provided using a physical token. The physical token may be of various types. In one example, the physical token may include machine readable data, such as a data token. The data token may be, for example, provided by the computing system performing the method 300 to the remote computing device and stored thereon after the first identity authentication has been successfully performed. This may allow the entity to then physically attend at a physical premises to allow the data token to be read by a computing system situated within that physical premises. By way of example, the physical identity token may be a barcode, QR code or data that may be read via NFC or the like. This may operate to verify that the entity is associated with a real person and not, for example, a computer or AI bot. Conveniently, in this way, the method 300 may be employed to reduce the risk of account creation by a computer or an AI bot.

In another example, the physical token may include an identification credential thereon. The identification credential may be the same identification credential used at the operation 320. For example, it may be an identity document.

In at least some implementations, the second identity authentication may be performed by scanning the physical token at a scanner situated at the physical premises. For example, an identity document, such as a passport or another type of identity document, or a physical token, may be scanned at the physical premises.

The second identity authentication may confirm that the entity scanning the physical token is the same entity that was authenticated at the operation 320. This may involve, for example, verifying facial features of the entity who is present at the physical premises. This verification may be performed using camera data from an on-site camera or other biometric scanner situated at the physical premises.

In response to determining that the second identity authentication has been successfully performed, the computing system performing the method 300 may unlock the second software feature at an operation 350. In doing so, the computing system grants access to additional software functionality in association with the logical storage area. The nature of such additional software functionality may vary. In one instance, this additional software functionality may enable an operation that is not yet enabled. For example, the additional software functionality may enable an outgoing transfer from the logical storage area. In another example, the additional software functionality may enable posting in association with a social media account. Other types of additional software functionality may be enabled in other implementations.

The method 300 described herein may be used for numerous cases. By way of example, it may enable for remote verification when an entity is not sufficiently close to a physical premises to authenticate in-person at the physical premises. Such authentication may be performed later, when the entity is closer to the physical premises, and, in the meantime, at least some software functionality may be enabled based on the remote authentication. This may be used in numerous possible scenarios including, for example, to allow for limited functionality on a social media platform before definitively confirming that the account-holder is not a bot, allowing for opening an account associated with a particular jurisdiction, such as a bank account, brokerage account, retirement account, etc. and allowing at least some functionality associated before authentication at the physical premises, opening a new messaging account such as an email account and allowing some limited functionality, such as allowing sending to a limited number of recipients, until authentication has been performed at a physical premises to confirm that the account-holder is not a spam bot, etc. In one example application, the methods and systems described herein may be used to partially provision an account, such as a bank account, for an entity in a foreign jurisdiction so that the account may receive incoming transfers before the customer arrives in a local jurisdiction and locally authenticates, at which time outgoing transfers may be enabled.

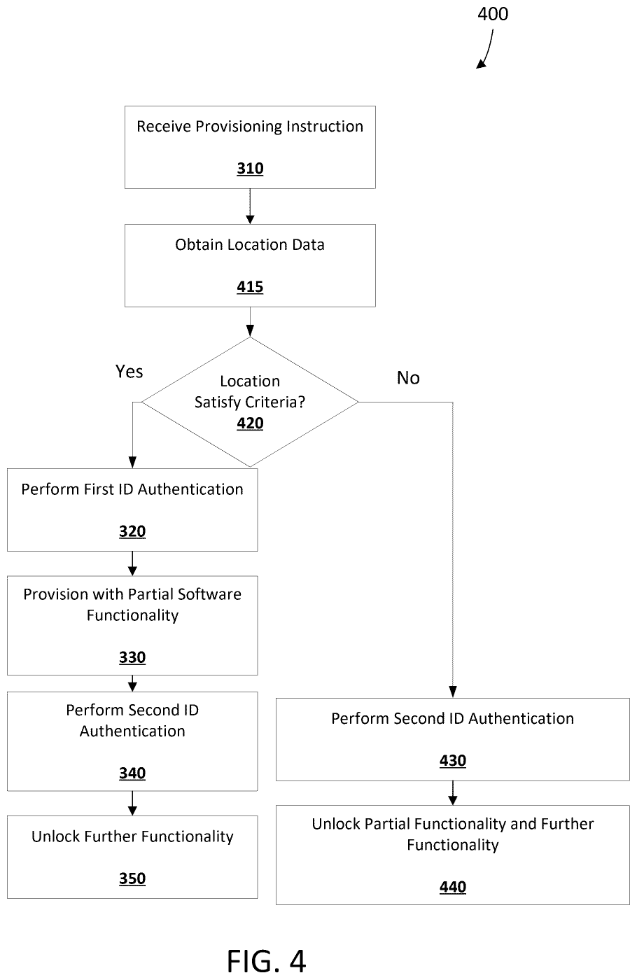

The method 300 of FIG. 3 may be modified. An example of one possible modification will now be discussed with reference to FIG. 4. FIG. 4 illustrates a flowchart of an example method 400 for unlocking functionality.

The method 400 may, in at least some implementations, be performed by one or both of a processor and a computer. For example, a memory may store instructions which, when executed, configure one or both of the processor and the computer to perform the method 400 or a portion thereof. For example, the method 400 may be performed by a computing system, such as the server computer system 120 (FIG. 1). For example, processor-executable instructions may cause the processor of the computing system to perform the method 400.

The method 400 may include any features described above with reference to the method 300 of FIG. 3. Such features are indicated with common reference numerals and the discussion of such features will not be repeated at length.

According to the method 400 of FIG. 4, the computing system performing the method 400 may operate differently depending on a location of the remote computing device from which a provisioning instruction is received.

The method 400 includes the operation 310, at which an instruction to provision a logical storage area is received. The operation 310 is described above with reference to the method 300 of FIG. 3. As described above with reference to the method 300 of FIG. 3, the instruction may be received from a remote computing device, which may be associated with an entity.

In response to receiving the provisioning instruction, the computing system performing the method 400 may, at an operation 415, obtain location data associated with the remote computing device. This may include determining a geographic location of the remote computing device. This may include determining a country within which the remote computing device is located, or it may include more granular location data.

There are several techniques that may be employed at the operation 415 to determine the location of the remote computing device. Such techniques may include one or more of: network-based methods including IP address geolocation, which estimates location based on the device's public IP address, cell tower triangulation and cell ID lookup which uses signals from nearby cell towers to approximate location, Wi-Fi Positioning System (WPS) which relies on nearby Wi-Fi networks and known databases, network signals and SIM card registration, Global Positioning System (GPS) which provides high accuracy using satellite signals, and Assisted GPS (AGPS) which combines GPS with network data, Bluetooth proximity and Wi-Fi MAC address, SIM-based and regulatory location tracking which may involve using a Mobile Country Code (MCC) from a SIM card to identify the country of registration, as well as tracking roaming status and network registration. Other techniques are also possible. At least some techniques may rely on a location obtained from a location system on the remote computing device.

At an operation 420, the method includes determining whether the location of the remote computing device satisfies defined criteria. This may include determining whether the remote computing device is inside or outside a geofence. For example, the defined criteria may be configured to be satisfied when the remote computing device is outside the geofence, but it may not be satisfied when the remote computing device is outside the geofence. In some implementations, the geofence may be defined based on a jurisdictional boundary. For example, the geofence may be defined based on a boundary associated with a country or a sub-regional boundary, such as a state, provincial or city boundary. Accordingly, in some instances, the defined criteria may be satisfied when the remote computing device is outside a particular jurisdictional boundary and it may not be satisfied when it is within the jurisdictional boundary.

In some implementations, the geofence may be defined relative to one or more physical premises at which the second identity authentication may be performed. For example, the physical premises may be a branch, store or other site at which authentication may be performed on-site. The geofence may be a particular distance from that physical premises. In some instances, the geofence may be dynamically determined and defined based on a population density in a region of the physical premises, or based on a density of physical premises at which the second identity authentication may be performed in that area. For example, less populated regions or regions with fewer such physical premises per unit area may have a larger geofence than more populated regions or regions with more physical premises per unit area.

If the computing system determines, at the operation 420, that the criteria is satisfied (i.e., that the remote computing device is too far away from the physical premises), then the remaining operations of the method 300 may be performed, beginning with the operation 320 at which the first identity authentication is performed. If, instead, the computing system determines that the criteria are not satisfied (i.e., that the remote computing device is not too far away from the physical premises), then the computing system may skip the operations 320 and 330. That is, the computing system may skip the remote authentication and may, instead, notify the remote computing device that the second identity authentication should be performed. This notification may include navigation data to facilitate routing to the physical premises.

The computing system may then, at the operation 430, perform the second authentication. This may be performed in the same manner as the operation 340. However, after the operation 430, both the first and second software features may be unlocked at an operation 440. That is, the graduated unlocking features may be skipped if the remote computing device is determined to be sufficiently proximate to the physical premises based on the techniques described above.

The method 400 may also be modified to evaluate other features instead of or in addition to location. For example, in one example, at the operation 415, the method 400 may evaluate other indicators of inconvenience. Other indicators of inconvenience may be indicators which suggest that it is not an opportune time for the remote computing device and/or the entity to physically attend at the physical premises. For example, such indicators may be based on a calendar on the remote computing device. An upcoming appointment may be interpreted as an indicator of inconvenience since it may suggest that the entity does not currently have time to physically attend at the physical premises. In such cases, the flow may proceed to the operation 320 where the remote authentication may be performed to enable partial unlocking.

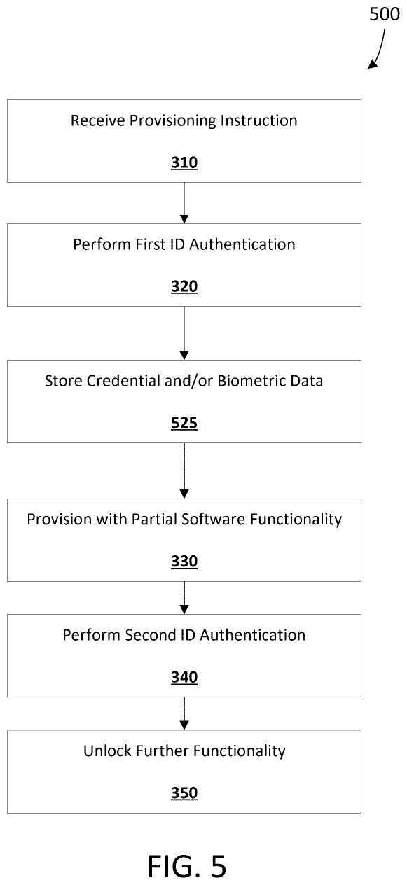

A further example of a possible modification to the methods described above will now be discussed with reference to FIG. 5. FIG. 5 illustrates a flowchart of an example method 500 for unlocking functionality.

The method 500 may, in at least some implementations, be performed by one or both of a processor and a computer. For example, a memory may store instructions which, when executed, configure one or both of the processor and the computer to perform the method 500 or a portion thereof. For example, the method 500 may be performed by a computing system, such as the server computer system 120 (FIG. 1). For example, processor-executable instructions may cause the processor of the computing system to perform the method 500.

The method 500 may include any features described above with reference to the method 300 of FIG. 3. Such features are indicated with common reference numerals and the discussion of such features will not be repeated at length. Further, while not illustrated in FIG. 5, the method 500 may include features of the method 400 of FIG. 4.

The method 500 may include one or more of the operations 310, 320, 330, 340 and 350 of the method 300. The method 500 includes the additional operation 525 after the operation 320. More specifically, at the operation 525, data that was used or obtained in order to perform the first identity authentication at the operation 320 may be stored; for example, in the data store 140. For example, one or both of the received representation of an identification credential and the biometric data captured at the remote computing device may be stored at the operation 525. This data may then be used to perform the second identity authentication at the operation 340. That is, the second identity authentication may then be performed based on one or both of the received representation of an identification credential and the biometric data captured at the remote computing device. The in-person authentication may effectively verify that the entity that has attended at the physical premises and that may be captured by a camera situated therein, is the same entity represented by one or both of the received representation of an identification credential and the biometric data captured at the remote computing device.

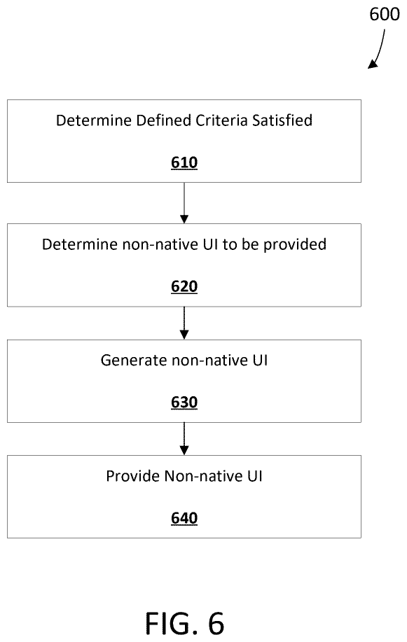

A further example method will now be discussed with reference to FIG. 6. FIG. 6 illustrates a flowchart of an example method 600 for providing a non-native user interface.

The method 600 may, in at least some implementations, be performed by one or both of a processor and a computer. For example, a memory may store instructions which, when executed, configure one or both of the processor and the computer to perform the method 600 or a portion thereof. For example, the method 600 may be performed by a computing system, such as the server computer system 120 (FIG. 1). For example, processor-executable instructions may cause the processor of the computing system to perform the method 600.

The method 600 may be performed together with another method described herein, in at least some implementations. For example, the method 600 may be performed in conjunction with one or more of the methods 300, 400, 500, 700 of FIGS. 3, 4, 5 and 7.

Country-specific user interfaces are sometimes prepared for users in various countries. However, some countries may not have a sufficient number of users to design native user interfaces that support local norms in such regions. This is especially true when the content of a user interface may be dynamic (e.g., it may change frequently), making it difficult to code country-specific user interfaces when content evolves. The method 600 may be performed to enable on-the-fly generation of a user interface when a user interface that has been customized to a particular region is not available.

The method 600 includes, at an operation 610, determining that one or both of a location associated with the remote computing device and a parameter received from the remote computing device satisfy defined criteria for augmenting a native user interface into a non-native user interface. The defined criteria may, for example, be satisfied when a remote computing device that is to receive the user interface is located in a jurisdiction satisfying defined criteria. For example, the jurisdiction may be a jurisdiction for which no native user interface is available.

In response to determining that one or both of the remote computing device and the parameter satisfy the defined criteria, the computing system performing the method may, at an operation 620, determine that a non-native user interface should be provided to the remote computing device.

In response to determining that one or both of the remote computing device and the parameter satisfy the defined criteria, the computing system may also, at an operation 630, generate the non-native user interface. The non-native user interface may be generated by passing one or more components of a native user interface to a machine learning system with an instruction to generate a non-native interface or components or content of the non-native interface. The instruction may define the jurisdiction within which the remote computing device is located.

At an operation 640, the method 600 may include providing the non-native user interface to the remote computing device. The non-native user interface may be output on the remote computing device.

In at least some implementations, the non-native user interface may be saved by the computing system performing the method 600 as a native user interface so that any subsequent requests for a user interface from the same jurisdiction may be provided with this stored user interface so that it does not have to be regenerated for other users. When the native user interface that was used at the operation 630 to generate the non-native user interface is modified, any user interface that was generated based on that native user interface and that was stored may be deleted. In this way, changes to the native user interface may be easily propagated to such other country-specific versions of the user interface without having to directly revise or modify such user interfaces.

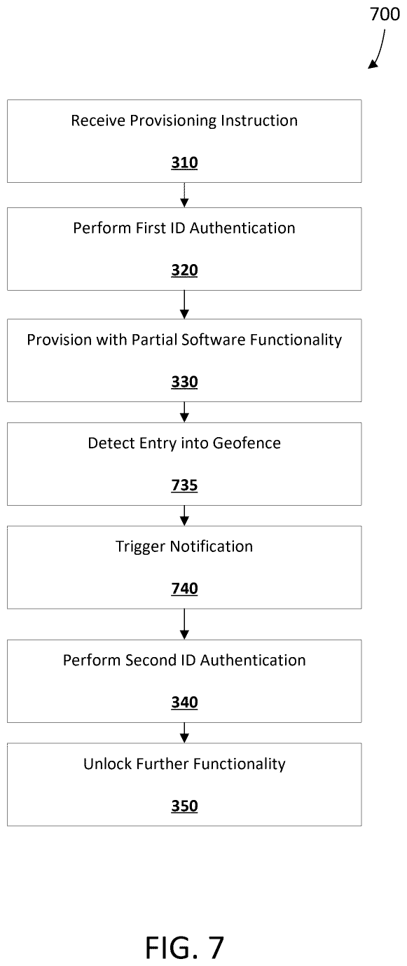

A further example method will now be discussed with reference to FIG. 7. FIG. 7 illustrates a flowchart of an example method 700 for unlocking software functionality.

The method 700 may, in at least some implementations, be performed by one or both of a processor and a computer. For example, a memory may store instructions which, when executed, configure one or both of the processor and the computer to perform the method 700 or a portion thereof. For example, the method 700 may be performed by a computing system, such as the server computer system 120 (FIG. 1). For example, processor-executable instructions may cause the processor of the computing system to perform the method 700.

The method 700 may include any features described above with reference to the method 300 of FIG. 3. Such features are indicated with common reference numerals and the discussion of such features will not be repeated at length. The method 700 may, additionally or alternatively, include features described with reference to another method herein.

The method 700 of FIG. 7 enables a notification to facilitate the second identity authentication. More specifically, the notification may be issued when a remote computing device that previously completed the remote identity authentication is determined to be proximate to a physical premises where the on-site authentication may be performed.

The method 700 may include the operations 310-330 in which the provisioning instruction is received (operation 310), the first identity authentication is performed (operation 320) and the logical storage area is provisioned with partial functionality (operation 330).

Then, the computing system may determine that the remote computing device has entered a geofence (operation 735). In some implementations, the geofence may be defined based on a jurisdictional boundary. For example, the geofence may be defined based on a boundary associated with a country or a sub-regional boundary, such as a state, provincial or city boundary. Accordingly, in some instances, at the operation 735, the computing system may determine that a remote computing device, that may have been outside of a particular jurisdictional boundary when the provisioning instruction was received, is now within the jurisdictional boundary.

In some implementations, the geofence may be defined relative to one or more physical premises at which the second identity authentication may be performed. For example, the physical premises may be a branch, store or other site at which authentication may be performed on-site. The geofence may be a particular distance from that physical premises.

In response to determining that the remote computing device has entered a geofence, at an operation 740, the computing system may trigger a notification at the remote computing device. The notification may facilitate the second identity authentication. For example, the notification may indicate that the entity must attend at the physical premises to perform the second identity authentication. The notification may provide directions to the physical premises.

Then, the operations 340-350 may be performed as described above.

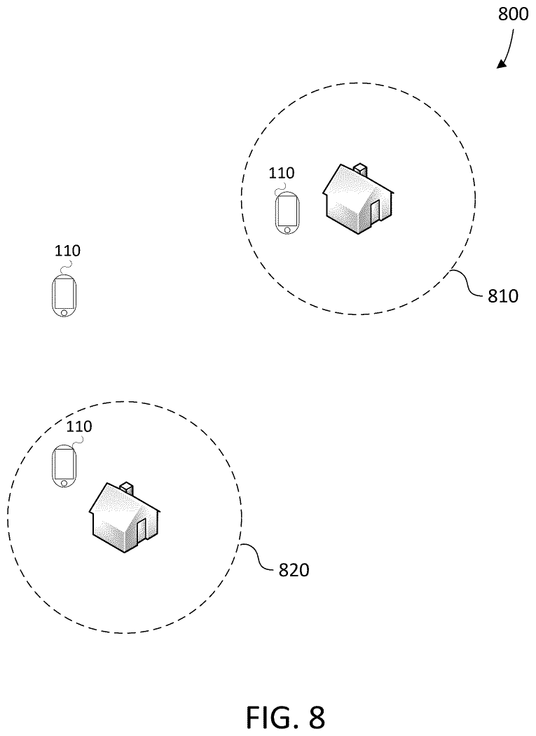

Reference will now be made to FIG. 8. FIG. 8 illustrates an example operating environment 800 in which example geofences 810, 820 are associated with physical premises. In the example, there are two geofences associated with two physical premises. This figure illustrates how a remote computing device 110 may, at various times, be situated within a first geofence 810, situated within a second geofence 820, or situated outside of any of the geofences. In some implementations, such as where the techniques of the method 400 of FIG. 4 are employed, when the remote computing device is situated outside of the geofences when the provisioning instruction is received (operation 310), the first identity authentication may be performed (at the operation 320) in order to partially unlock software functionality. However, in at least some such implementations, when it is situated inside of the geofences when the provisioning instruction is received (operation 310), the first identity authentication is skipped in favor of more fulsome unlocking using the second identity authentication.

FIG. 8 may also be considered in the context of the method 700 of FIG. 7. In that method 700, the remote computing device may be situated outside of the geofences 810, 820 when the provisioning instruction is received (operation 310) and when it travels within one of the geofences 810, 820, the notification may be triggered (operation 740).

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computing system for provisioning a logical storage area, the computing system comprising:
a network interface;
a processor in communication with the network interface; and
a memory coupled to the processor, the memory storing processor-executable instructions which, when executed, cause the processor to:
receive, via the network interface and from a remote computing device, an instruction to provision a logical storage area, the instruction including identification data;
perform a first identity authentication based on a received representation of an identification credential and biometric data captured at the remote computing device, the first identity authentication confirming that:
the biometric data captured at the remote computing device corresponds to biometric data represented by the identification credential; and
the identification credential corresponds to the identification data; and
in response to successfully performing the first identity authentication, provision the logical storage area with an unlocked first software feature and a locked second software feature;
after provisioning the logical storage area:
determine that a second identity authentication has been successfully performed, the second identity authentication using a different authentication technique than the first identity authentication; and
in response to determining that the second identity authentication has been successfully performed, unlock the second software feature to grant access to additional software functionality in association with the logical storage area.

2. The computing system of claim 1, wherein the first identity authentication provides for remote identity verification and wherein the second identity authentication requires local identity verification which requires physical verification at a physical premises.

3. The computing system of claim 2, wherein physical verification at the physical premises is provided using a physical token.

4. The computing system of claim 3, wherein the physical token is associated with the identification credential.

5. The computing system of claim 4, wherein the second identity authentication is performed by scanning the physical token at a scanner situated at the physical premises.

6. The computing system of claim 1, wherein the instructions further configure the processor to:
determine that a location of the remote computing device satisfies defined criteria,
and wherein the first identity authentication is performed in response to determining that the location of the remote computing device satisfies the defined criteria.

7. The computing system of claim 6, wherein the defined criteria are configured to be satisfied when the remote computing device is outside a geofence but that it is not satisfied when the remote computing device is inside the geofence.

8. The computing system of claim 7, wherein the geofence is defined based on a jurisdictional boundary.

9. The computing system of claim 1, wherein the first identity authentication uses one or both of computer vision techniques and machine learning to confirm that the biometric data captured at the remote computing device corresponds to the biometric data represented by the identification credential.

10. The computing system of claim 1, wherein the identification credential is an officially-issued identification credential.

11. The computing system of claim 1, wherein the first software feature enables performance of a computing operation of a first type and wherein the second software feature enables performance of a computing operation of a second type.

12. The computing system of claim 1, wherein unlocking the first software feature enables accepting incoming electronic messages in association with the logical storage area and wherein unlocking the second software feature enables sending outgoing electronic messages in association with the logical storage area.

13. The computing system of claim 1, wherein unlocking the first software feature enables performing of a first computing operation based on a received incoming electronic message in association with the logical storage area and wherein unlocking the second software feature enables sending outgoing electronic messages in association with the logical storage area to affect a second computing operation.

14. The computing system of claim 1, wherein the instructions further configure the processor to:
store one or both of the received representation of an identification credential and the biometric data captured at the remote computing device,
and wherein the second identity authentication is performed based on one or both of the received representation of an identification credential and the biometric data captured at the remote computing device.

15. The computing system of claim 1, wherein the instructions further configure the processor to:
determine that one or both of a location associated with the remote computing device and a parameter received from the remote computing device satisfy defined criteria for augmenting a native user interface into a non-native user interface;
in response to determining that one or both of the remote computing device and the parameter satisfy the defined criteria:
determine that the non-native user interface is to be provided to the remote computing device;
generate the non-native user interface by passing one or more components of a native user interface to a machine learning system with an instruction to generate the non-native interface; and
provide the non-native user interface to the remote computing device,
and wherein the instruction is received via the non-native interface.

16. The computing system of claim 1, wherein the instructions further cause the processor to:
determine that the remote computing device has entered a geofence; and
in response to determining that the remote computing device has entered the geofence, trigger a notification at the remote computing device, the notification facilitating the second identity authentication.

17. A computer-implemented method comprising:
receiving, from a remote computing device, an instruction to provision a logical storage area, the instruction including identification data;
performing a first identity authentication based on a received representation of an identification credential and biometric data captured at the remote computing device, the first identity authentication confirming that:
the biometric data captured at the remote computing device corresponds to biometric data represented by the identification credential; and
the identification credential corresponds to the identification data; and
in response to successfully performing the first identity authentication, provisioning the logical storage area with an unlocked first software feature and a locked second software feature;
after provisioning the logical storage area:
determining that a second identity authentication has been successfully performed, the second identity authentication using a different authentication technique than the first identity authentication; and
in response to determining that the second identity authentication has been successfully performed, unlocking the second software feature to grant access to additional software functionality in association with the logical storage area.

18. The method of claim 17, wherein the first identity authentication provides for remote identity verification and wherein the second identity authentication requires local identity verification, which requires physical verification at a physical premises.

19. The method of claim 18. wherein physical verification at the physical premises is provided using a physical token.

20. The method of claim 19. wherein the physical token is associated with the identification credential.
